(19) United States
(12) Patent Application Publication
(10) Pub. No.: US 2015/0230450 A1
(43) Pub. Date: Aug. 20, 2015

(54) ULTRASONIC INTRUSION DETERRENCE APPARATUS AND METHODS

(71) Applicant: Turtle Beach Corporation, Poway, CA (US)

(72) Inventor: Elwood Grant Norris, Poway, CA (US)

(73) Assignee: Turtle Beach Corporation, Poway, CA (US)

(21) Appl. No.: 14/627,864

(22) Filed: Feb. 20, 2015

Related U.S. Application Data
(60) Provisional application No. 61/942,229, filed on Feb. 20, 2014.
(60) Provisional application No. 61/946,635, filed on Feb. 28, 2014.

(51) Int. Cl. A01M 29/18; G08B 15/00

(52) U.S. Cl. CPC A01M 29/18; G08B 15/00

(57) ABSTRACT

An intrusion system can be configured to includes a detection module comprising a processing module and a sensor having an output coupled to the processing module, wherein the detection module is configured to detect an object in a predetermined area and to determine a position of the detected object in the predetermined area; an ultrasonic generator comprising an oscillator configured to generate an ultrasonic signal; and an ultrasonic emitter coupled to the ultrasonic generator configured to launch an ultrasonic wave toward the position of the detected object.

### RELATED APPLICATIONS

This application claims the benefit of U.S. Provisional Application Nos. 61/942,229 filed Feb. 20, 2014 and 61/946,635 filed Feb. 28, 2014.

### TECHNICAL FIELD

The present disclosure relates generally to ultrasonic emission systems. More particularly, some embodiments relate to systems and methods for using ultrasonic energy to deter entry or control behavior.

### BACKGROUND

Certain areas can be hazardous to mammals or other creatures that may venture into such areas. For example, certain areas such as ammunition test ranges, windmill farms, solar energy generating stations, airports, and other areas often include instrumentalities they can pose risk of physical harm to objects such as birds, bats, humans and other creatures that may enter into their vicinity. Likewise, these unwanted intruders can also cause harm to people living or working in those environments as well as to the equipment at such facilities. These and other environments, including environments that don't normally cause a threat to objects and their vicinity, may benefit from an object detection system that can detect the presence of objects in a predefined region.

### SUMMARY

Embodiments of the systems and methods described herein provide novel systems and methods that can be used to deter entry or control behavior using the delivery of ultrasonic energy in a modulated, or unmodulated, form. Systems and methods described herein can be configured to detect the approach of an unwanted potential intruder, or the entry of an unwanted intruder into a monitored area. The systems and methods can further be configured to determine the position of such intruders, track their movement and trajectory, and deliver ultrasonic energy to deter the intruder from such intrusion, or to influence or cause the intruder to change course or retreat.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

Some of the figures included herein illustrate various embodiments of the disclosed technology from different viewing angles. Although the accompanying descriptive text may refer to such views as “top,” “bottom” or “side” views, such references are merely descriptive and do not imply or require that the disclosed technology be implemented or used in a particular spatial orientation unless explicitly stated otherwise.

FIG. 1 is a diagram illustrating an ultrasonic sound system suitable for use with the emitter technology described herein.

FIG. 2 is a diagram illustrating another example of a signal processing system that is suitable for use with the emitter technology described herein.

FIG. 3A is a diagram illustrating a cross sectional view of a portion of an irregular surface comprising ridges in accordance with one embodiment of the technology described herein.

FIG. 3B is a diagram illustrating a perspective view of a plurality of rows of the surface of one embodiment of the backing plate shown in FIG. 3A.

FIG. 3C is a diagram illustrating a perspective view of irregularities formed in the shape of peaks (rather than elongated ridges) used to form an irregular surface in accordance with one embodiment of the technology described herein.

FIG. 4 is a diagram illustrating a cross sectional view of a portion of another embodiment having irregular surface comprising ridges.

FIG. 5, which comprises FIGS. 5A and 5B, illustrates exemplary dimensions for a textured surface in accordance with embodiments described above with reference to FIGS. 3 and 4.

FIG. 6, which comprises FIGS. 6A and 6B, provides yet another alternative embodiment for textural elements of the backing plate. FIG. 6A is a cross sectional view of a textural element in accordance with one embodiment of the technology described herein, while FIG. 6B presents a perspective view.

FIG. 7 is a diagram illustrating an example of a contour having a plurality of textural elements such as those illustrated in FIG. 6.

FIG. 8 is a diagram illustrating an example of a contour in which a radiused surface is provided between each of the adjacent ridges.

FIG. 9 is a diagram illustrating another example of a contour.

FIGS. 10A and 10B is a diagram illustrating exemplary dimensions for a textured surface in accordance with embodiments described above.

FIGS. 11A and 12A are diagrams illustrating an example of an emitter in an arcuate configuration.

FIGS. 11B and 12B are diagrams illustrating an example of an emitter in a cylindrical configuration

FIG. 13 is a diagram illustrating an example architecture for an intrusion detection system.

FIG. 14 illustrates an example computing module that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DESCRIPTION

Embodiments of the systems and methods described herein provide novel systems and methods that can be used to deter entry or control behavior using the delivery of ultrasonic energy in a modulated, or unmodulated, form. Systems and methods described herein can be configured to detect the approach of an unwanted potential intruder, or the entry of an unwanted intruder into a monitored area. The systems and methods can further be configured to determine the position of such intruders, track their movement and trajectory, and deliver ultrasonic energy to deter the intruder from such intrusion, or to influence or cause the intruder to change course or retreat.

In various embodiments, a tracking system can be configured to scan or search for and detect the presence or appearance of one or more approaching entities, determine whether the approaching entities are unwanted intruders, determine the position, movement and trajectory of unwanted intruders, and deliver ultrasonic energy in an effort to deter unwanted intruders from continuing to approach a defined restricted area or to influence the intruders to leave the defined restricted area. The tracking system can use and adapt any of a number of commonly known tracking technologies to detect, determine the location of, and track the presence of approaching entities and intruders. This can include, for example, electromagnetic detection systems such as radar, lidar, ultrasonic, infrared, optical, and other like detection technologies. Additionally, manual detection, positioning and tracking can be implemented through the use of human observers with or without the aid of technology such as binoculars, night vision glasses, and other detection aids.

Upon the detection and identification of an unwanted intruder, the tracking system can determine the intruder's position and provide this information to a control system. The control system can cause ultrasonic energy to be deployed to the determined position (or along the determined path or trajectory) to cause the intruder to change its course or retreat from continuing toward a restricted area, or to leave the vicinity of the restricted area entirely. For example, in various embodiments, an array of ultrasonic emitters configured to emit ultrasonic energy (e.g., in the range of 30 kHz to 150 kHz,) can be provided. Emitters at other frequencies can also be used, including frequencies outside of the ultrasonic spectrum. The emitter array can comprise a plurality of ultrasonic emitters aimed in various directions to cover the restricted area and its periphery. Because of the highly directional nature of ultrasonic signals, the plurality of emitters can be mounted such that their energy is emitted in the plurality of different directions. In various embodiments, phased arrays can be used to facilitate directionality of the ultrasonic emissions. Likewise, gimbaled or other like movable mounts can be used to allow the pointing of ultrasonic emitters to the target locations (i.e. to the location of the intruder), and to allow the ultrasonic emitters to track the intruder along its path of movement.

Control of the mounts or the phased array to aim the ultrasonic signals at the intruder can be provided by the control system. The control system can also be used to control the delivery of ultrasonic energy by one or more emitters. Information from the tracking and detection system can be used to confirm that the delivery of ultrasonic energy to the intruder has had its desired effect. In other words, the tracking and detection system can be used to determine if the identified intruder has ceased its forward motion, reversed course or otherwise departed. The control system can inform users in real-time of intruders, the system operation, the effect of its operation, and other information as may be desired. The control system can also log events for historic, reporting, and record-keeping purposes.

In various embodiments, the energy used to deter intrusion can simply be an unmodulated signal such as, for example, an ultrasonic signal. In other embodiments, audio or other information can be modulated onto a carrier to facilitate intrusion deterrence.

For use with the intrusion detection and deterrence system, any of a number of ultrasonic emitter technologies can be used. These can include, for example, piezo electric emitters, electrostatic emitters, or other ultrasonic emitters. Likewise, any of a number of modulation schemes can be used to modulate audio content or other information onto an ultrasonic carrier, and the modulated signal can include double side band and single sideband modulation.

Before describing the technology in further detail, it is useful to describe an example environment with which this technology can be implemented. After reading this description, it will become apparent to one of ordinary skill in the art how this technology can be implemented in other alternative environments. One example environment includes a solar power generation facility that uses a plurality of mirrors to direct solar energy to one or more central collectors. The collected energy is used to heat a substance such as water to generate electricity from steam. The mirrors can be mounted as heliostats so that they track the sun and reflect its energy to the central collectors. Multiple collectors can be used to optimize the collection of energy from a plurality of mirrors arranged about a given area.

One concern that has arisen with the use of such a facility is the environmental impact to the local habitat in the area of the power generation facility. Because of the intense heat that can be created with the concentration of sunlight at or near the centralized collectors, the plant can provide a hazard to birds or other animals or creatures in the vicinity. For example, birds flying in regions between the mirrors and the central collectors can fly into regions of intense heat, injuring or even killing the birds. Accordingly, the use of an ultrasonic intrusion deterrence system with such an environment can be used to detect the presence of birds or other animals nearing the area, determine their trajectory and location, and deter the birds from flying through regions of high temperature.

After reading this document, it will become apparent to those of ordinary skill in the art how the systems and methods described herein can be used in alternative environments for intrusion detection and deterrence. For example, the systems and methods described herein can be used with facilities or areas that may present a danger to humans, animals, or other creatures, or other facilities or areas where intrusion is unwanted for a variety of reasons. Likewise, the technology described herein can be used to detect and redirect vehicles or other equipment as well.

As noted above, in some embodiments the ultrasonic signal itself is sufficient to deter intrusion. However, in other embodiments, audio content can be modulated onto the ultrasonic carrier to facilitate or enhance intrusion deterrence. For example, audible warnings can be transmitted and sent to the intruder to warn the intruder away from the restricted area. For example, in the case of birds as intruders, random noises or “unpleasant” sounds may be sufficient. As a further example, the sound of the birds' natural predators modulated onto the ultrasonic carrier may serve as a suitable deterrent.

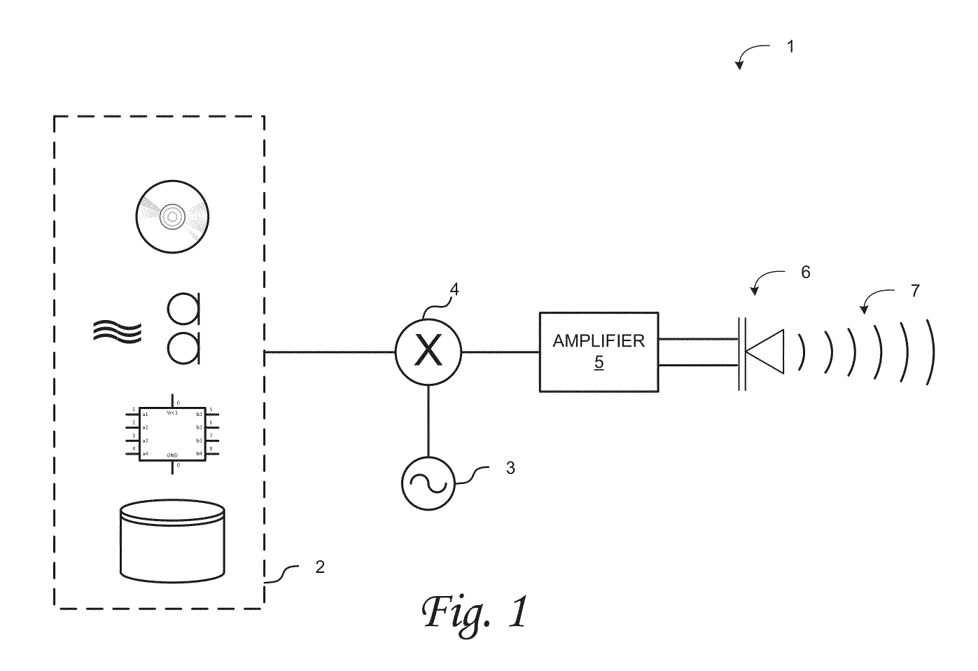

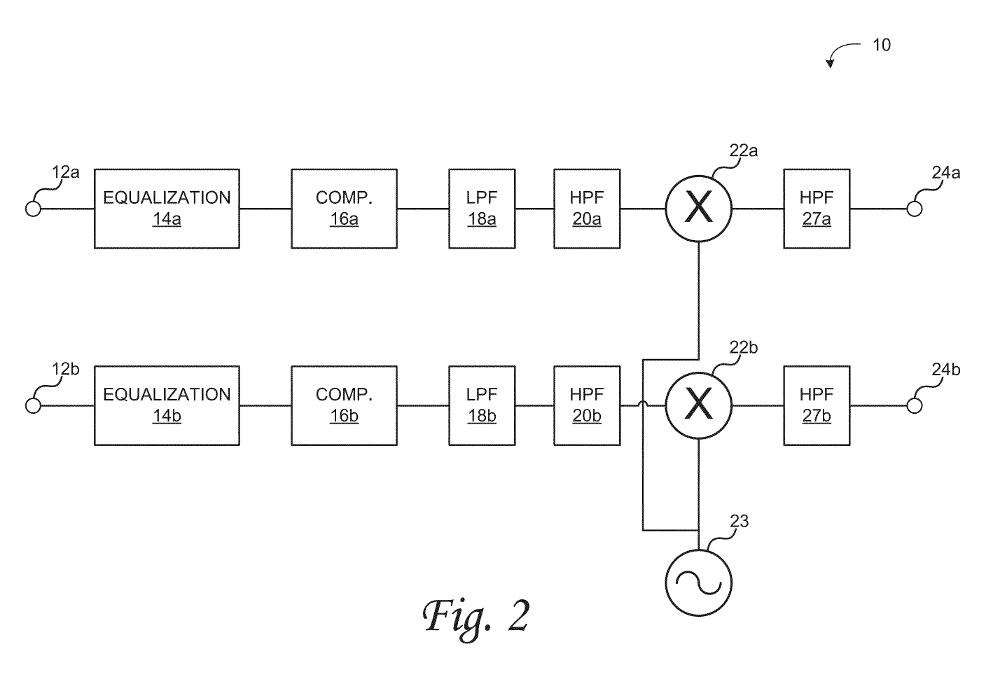

FIGS. 1 and 2 describe examples embodiments for modulating audio content onto an ultrasonic carrier. The systems provide an example of how audio information can be modulated onto and communicated using an ultrasonic carrier with the systems and methods described herein. FIG. 1 is a diagram illustrating an audio modulated ultrasonic carrier system in accordance with one embodiment of the technology described herein. In this exemplary ultrasonic system 1, audio content from an audio source 2, such as, for example, a microphone, memory, a data storage device, streaming media source, CD, DVD or other audio source is received. The audio content may be decoded and converted from digital to analog form, depending on the source. The audio content received by the audio system 1 is modulated onto an ultrasonic carrier of frequency f1, using a modulator. The modulator typically includes a local oscillator 3 to generate the ultrasonic carrier signal, and multiplier 4 to modulate the audio signal on the carrier signal. The resultant signal is a double- or single-sideband signal with a carrier at frequency f1. In some embodiments, signal is a parametric ultrasonic wave or an HSS signal. In most cases, the modulation scheme used is amplitude modulation, or AM. AM can be achieved by multiplying the ultrasonic carrier by the information-carrying signal, which in this case is the audio signal. The spectrum of the modulated signal has two sidebands, an upper and a lower side band, which are symmetric with respect to the carrier frequency, and the carrier itself.

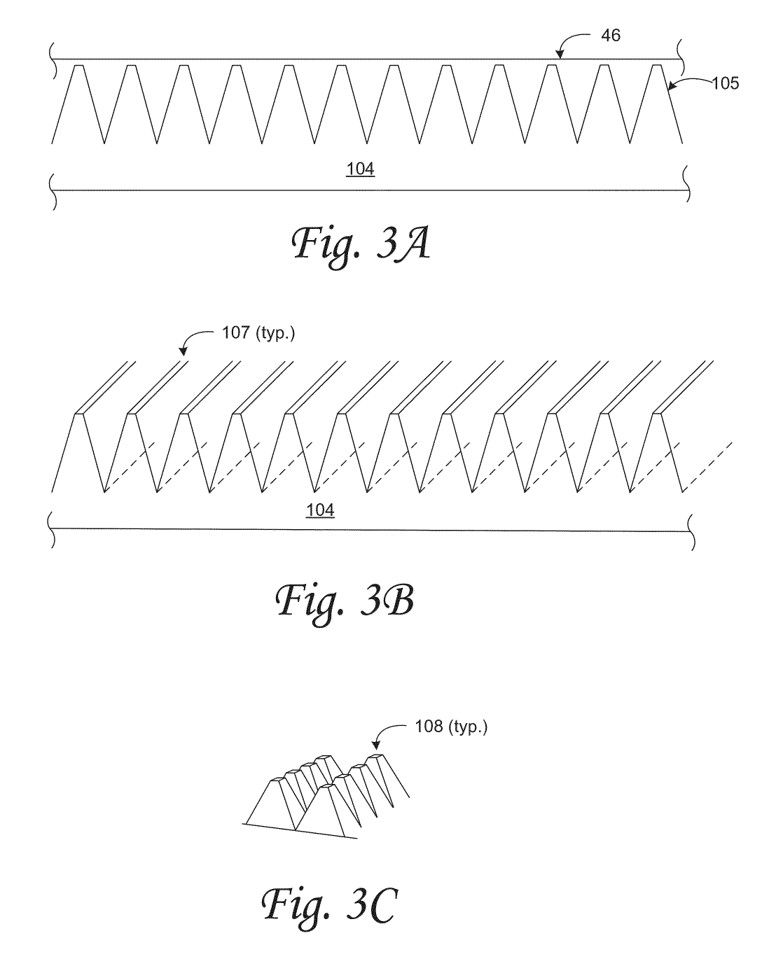

The modulated ultrasonic signal is provided to the transducer 6, which launches the ultrasonic wave into the air creating ultrasonic wave 7. When played back through the transducer at a sufficiently high sound pressure level, due to nonlinear behavior of the air through which it is ‘played’ or transmitted, the carrier in the signal mixes with the sideband(s) to demodulate the signal and reproduce the audio content. This is sometimes referred to as self-demodulation. Thus, even for single-sideband implementations, the carrier is included with the launched signal so that self-demodulation can take place. Although the system illustrated in FIG. 3 uses a single transducer to launch a single channel of audio content, one of ordinary skill in the art after reading this description will understand how multiple mixers, amplifiers and transducers can be used to transmit multiple channels of audio using ultrasonic carriers.

One example of a signal processing system 10 that is suitable for use with the technology described herein is illustrated schematically in FIG. 2. In this embodiment, various processing circuits or components are illustrated in the order (relative to the processing path of the signal) in which they are arranged according to one implementation. It is to be understood that the components of the processing circuit can vary, as can the order in which the input signal is processed by each circuit or component. Also, depending upon the embodiment, the processing system 10 can include more or fewer components or circuits than those shown.

Also, the example shown in FIG. 1 is optimized for use in processing two input and output channels (e.g., a “stereo” signal), with various components or circuits including substantially matching components for each channel of the signal. It will be understood by one of ordinary skill in the art after reading this description that the audio system can be implemented using a single channel (e.g., a “monaural” or “mono” signal), two channels (as illustrated in FIG. 2), or a greater number of channels.

Referring now to FIG. 2, the example signal processing system 10 can include audio inputs that can correspond to left 12A and right 12b channels of an audio input signal. Equalizing networks 14a, 14b can be included to provide equalization of the signal. The equalization networks can, for example, boost or suppress predetermined frequencies or frequency ranges to increase the benefit provided naturally by the emitter/inductor combination of the parametric emitter assembly.

After the audio signals are compressed, Compressor circuits 16a, 16b can be included to compress the dynamic range of the incoming signal, effectively raising the amplitude of certain portions of the incoming signals and lowering the amplitude of certain other portions of the incoming signals. More particularly, compressor circuits 16a, 16b can be included to narrow the range of audio amplitudes. In one aspect, the compressors lessen the peak-to-peak amplitude of the input signals by a ratio of not less than about 2:1. Adjusting the input signals to a narrower range of amplitude can be done to minimize distortion, which is characteristic of the limited dynamic range of this class of modulation systems. In other embodiments, the equalizing networks 14a, 14b can be provided before compressors 16a, 16b, to equalize the signals after compression. In alternative embodiments, the compression can take place before equalization.

Low pass filter circuits 18a, 18b can be included to provide a cutoff of high portions of the signal, and high pass filter circuits 20a, 20b providing a cutoff of low portions of the audio signals. In one exemplary embodiment, low pass filters 18a, 18b are used to cut signals higher than about 15 kHz-20 kHz, and high pass filters 20a, 20b are used to cut signals lower than about 20-200 Hz.

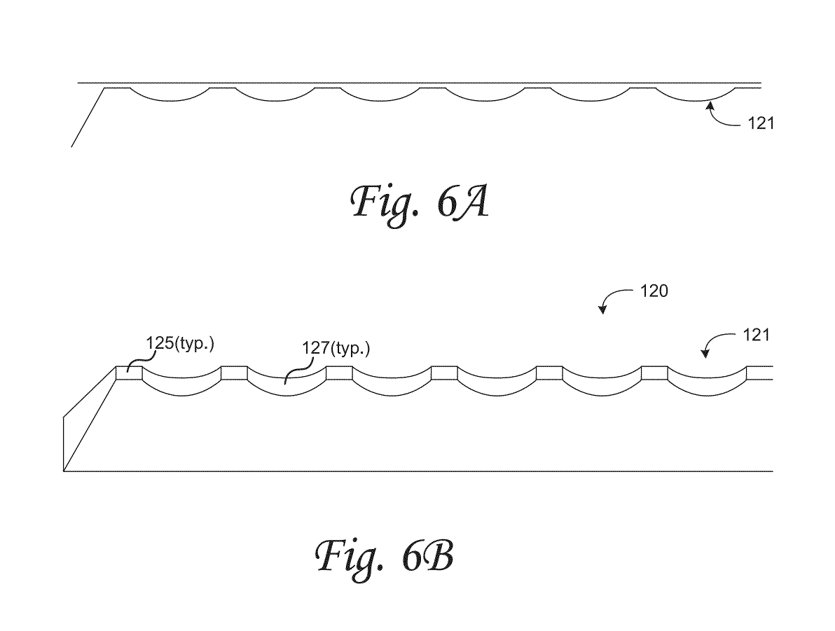

The high pass filters 20a, 20b can be configured to eliminate low frequencies that, after modulation, would result in deviation of carrier frequency (e.g., those portions of the modulated signal of FIG. 6 that are closest to the carrier frequency). Also, some low frequencies are difficult for the system to reproduce efficiently and as a result, much energy can be wasted trying to reproduce these frequencies. Therefore, high pass filters 20a, 20b can be configured to cut out these frequencies.

The low pass filters 18a, 18b can be configured to eliminate higher frequencies that, after modulation, could result in the creation of an audible beat signal with the carrier. By way of example, if a low pass filter cuts frequencies above 15 kHz, and the carrier frequency is approximately 44 kHz, the difference signal will not be lower than around 29 kHz, which is still outside of the audible range for humans. However, if frequencies as high as 25 kHz were allowed to pass the filter circuit, the difference signal generated could be in the range of 19 kHz, which is within the range of human hearing.

In the example system 10, after passing through the low pass and high pass filters, the audio signals are modulated by modulators 22a, 22b. Modulators 22a, 22b, mix or combine the audio signals with a carrier signal generated by oscillator 23. For example, in some embodiments a single oscillator (which in one embodiment is driven at a selected frequency of 40 kHz to 50 kHz, which range corresponds to readily available crystals that can be used in the oscillator) is used to drive both modulators 22a, 22b. By utilizing a single oscillator for multiple modulators, an identical carrier frequency is provided to multiple channels being output at 24a, 24b from the modulators. Using the same carrier frequency for each channel lessens the risk that any audible beat frequencies may occur.

High-pass filters 27a, 27b can also be included after the modulation stage. High-pass filters 27a, 27b can be used to pass the modulated ultrasonic carrier signal and ensure that no audio frequencies enter the amplifier via outputs 24a, 24b. Accordingly, in some embodiments, high-pass filters 27a, 27b can be configured to filter out signals below about 25 kHz.

Although the embodiments described above with reference to FIGS. 1 and 2 describe driving ultrasonic emitters using audio-modulated ultrasonic carriers, other information modulated onto carriers can also be used with the various systems and methods described herein. For example, codes, computer-readable instructions, machine-readable instructions, or other like electronic information can be modulated onto a carrier (ultrasonic or otherwise) and directed at a vehicle to request or instruct that the vehicle change its path or retreat from the area.

As noted above, in some embodiments the ultrasonic signal itself, without modulation, can be used to deter intrusion. For example, the ultrasonic signal itself can be detected by certain animals and can cause those animals to retreat or move away from the sound. However, some animals (including humans) are not capable of hearing the ultrasonic signal itself. For example, in terms of the example environment described above, birds are not capable of hearing an ultrasonic signal. Scientists have determined that the hearing range of most birds is limited to a maximum of approximately 5 kHz to 10 kHz. Indeed, peak sensitivities of most species of birds tends to be below 4 kHz. Accordingly, an ultrasonic signal of 30 kHz or higher is not itself directly audible to birds, and is far from the peak sensitivity of birds.

However, subharmonic distortion of an ultrasonic signal within the bird's ear (whether in the outer, middle, or inner ear), can produce an audibly detectable signal from an ultrasonic signal at the appropriate frequency. The frequency at which this audible signal is generated (referred to herein as the characteristic frequency) can vary depending on a number of factors. In other words, the inaudible ultrasonic signal impinging on the bird (or other intruder) may, if properly selected, result in an auditory signal being generated within the head of the bird. These factors can include, for example, the bone density and bone size of the ossicles, skull, or other bones related to or surrounding the ear; the size and shape of the vestibular organs; the size and volume of the cochlea; and other like factors.

Harmonics of the ultrasonic frequency are typically at even integer fractions of the center frequency. That is they are typically, for example f/2, f/4, f/8, etc., with f being the center frequency. However, the lower order subharmonics tend to be more attenuated than the higher order upper harmonics. Therefore, a center frequency can be chosen for the ultrasonic transmission to have a harmonic frequency at or near the characteristic frequency of the bird's (or other subject's) ear. For example, the characteristic frequency in the human ear tends to be in the range of 8 to 10 kHz to 12 kHz. Accordingly, selecting a center frequency for the ultrasonic signal in the 30 kHz to 40 kHz range will produce a subharmonic (e.g. at f/4) at about 8 kHz to 10 kHz. As yet another example, selecting a frequency for the ultrasonic signal in the range of 15 kHz to 20 kHz will produce a subharmonic at F/2 in the range of 7.5 kHz to 10 kHz.

Any of a number of ultrasonic emitters can be used with the technology disclosed herein. A few examples of emitters and associated technology that can be used with the systems and methods disclosed herein include those emitters and associated technology disclosed in U.S. Pat. No. 8,718,297, to Norris, titled Parametric Transducer and Related Methods, which is incorporated by reference herein in its entirety as if reproduced in full below. It will also be appreciated by those of ordinary skill in the art after reading this description how the technology can be implemented using other ultrasonic emitters and alternative driver circuitry.

As noted above, in various embodiments the conductive backing plate in the emitter is provided with an irregular surface. To create an irregular surface, in embodiments discussed above the surface can be embossed, stamped, sanded, sand blasted, formed with pits or irregularities in the surface, deposited with a desired degree of ‘orange peel’ or otherwise provided with texture. In other embodiments, conductive surface 45 can comprise a conductive plate or other member that is formed or provided with ridges or other like textural elements to present an irregular surface to the conductive emitter film 46.

FIG. 3A is a diagram illustrating a cross sectional view of a portion of an irregular surface comprising ridges in accordance with one embodiment of the technology described herein. In the example illustrated in FIG. 3A, a conductive backing plate 104 is provided with a ridged surface 105. The peaks of ridged surface 105 support conductive layer 46. Although conductive layer 46 is shown as spaced apart from the peaks of ridged surface 105, conductive layer 46 can rest on or come into contact with the peaks of ridged surface 105. In some embodiments, conductive layer 46 comprises a conducting layer 46a and an insulating layer 46b separating conducting layer 46a from the peaks. Although not illustrated, when a bias voltage is applied across the emitter, conductive layer 46 will be drawn into more stable contact with surface 105, causing layer 46 to contact the peaks and, with sufficient bias, be drawn down at least partially into the valleys. Preferably, the bias is not sufficiently strong to draw layer 46 into complete contact with the entirety of surface 105, as some air volume is desired to allow layer 46 to move in response to application of the audio modulated ultrasonic signal.

FIG. 3B is a diagram illustrating a perspective view of a plurality of rows of the surface of one embodiment of the backing plate 104 shown in FIG. 3A. In the illustrated example, the peaks of ridged surface 105 extend in length across all or a portion of the backing plate 104. Sections of backing plate 104 can be fabricated with elongated textural elements 107 (in this example, substantially uniform ridges) extending roughly in parallel across all or sections of the backing plate 104. In other embodiments, the irregularities 107 in surface 105 are of shorter lengths. FIG. 3C is a diagram illustrating a perspective view of irregularities formed in the shape of peaks (rather than elongated ridges) used to form an irregular surface. In the example illustrated in FIG. 3C, the surface irregularities are in the form of square pyramids (with a truncated, flattened peak), although rectangular pyramids could also be used. Although the edges of the surface irregularities (e.g., ridges 107 of FIG. 3B and pyramids 108 of FIG. 3C) are shown as having sharp edges, some or all of the edges of the surface irregularities can have larger radii (i.e., they can be softened or less sharp).

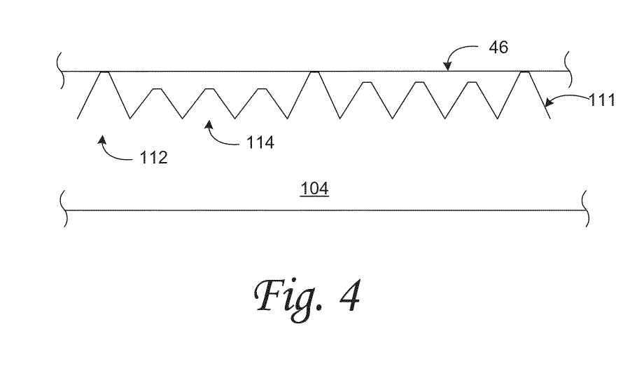

In the embodiments illustrated in FIG. 3B, the height of each of the peaks is substantially uniform, or substantially the same height. In alternative embodiments, the height of the peaks of ridges can vary from row to row or peak to peak. FIG. 4 is a diagram illustrating a cross sectional view of a portion of another embodiment having irregular surface comprising ridges. In the embodiment illustrated in FIG. 4, the peaks of the ridged surface 15 Are of different heights. In particular, there are a plurality of shorter peaks 114 bounded by taller peaks 112. In this example, peaks 112 are loaded peaks in that they support the emitter layer 46. Shorter peaks 114 are unloaded peaks and can be provided at a height chosen to provide a desired air volume between emitter layer 46 and backing plate 104. As with the embodiment illustrated and described with reference to FIG. 3B, surface 111 can comprise a plurality of elongated ridges extending across all or sections of backing plate 104. Alternatively, as with the embodiment illustrated and described above with reference to FIG. 3C, surface 111 can comprise a plurality of square or rectangular pyramids disposed on or forming the surface of backing plate 104. In this case, the loaded pyramids can be arranged in rows such that there are rows of loaded pyramids adjacent multiple rows of unloaded pyramids. Alternatively, the loaded pyramids can be arranged such that they are surrounded by unloaded pyramids.

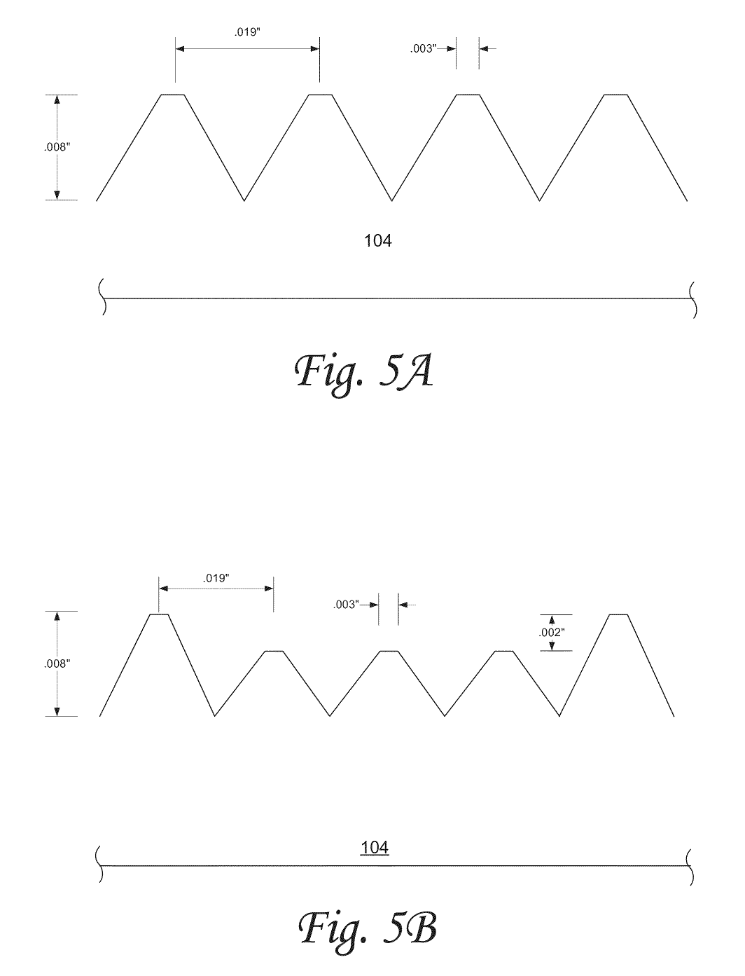

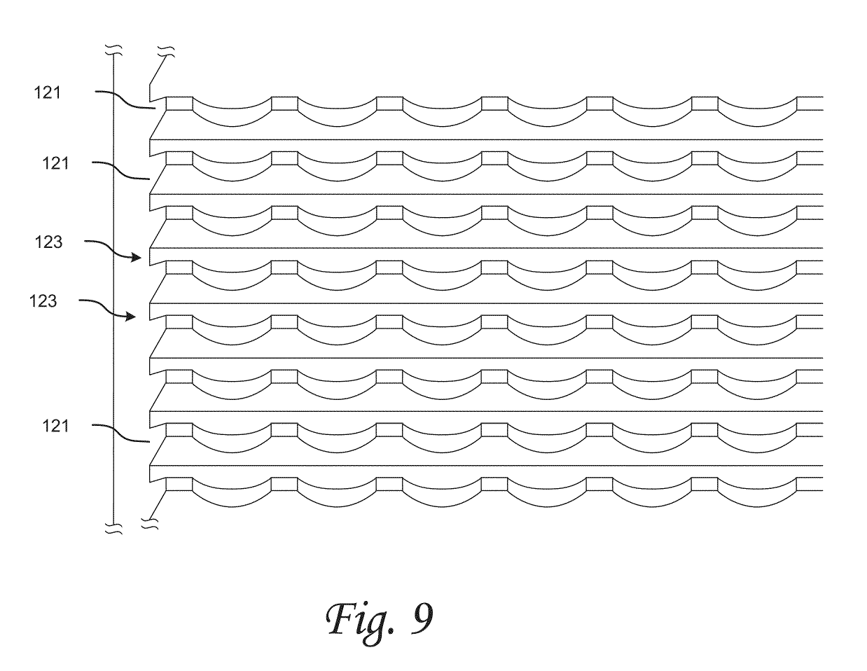

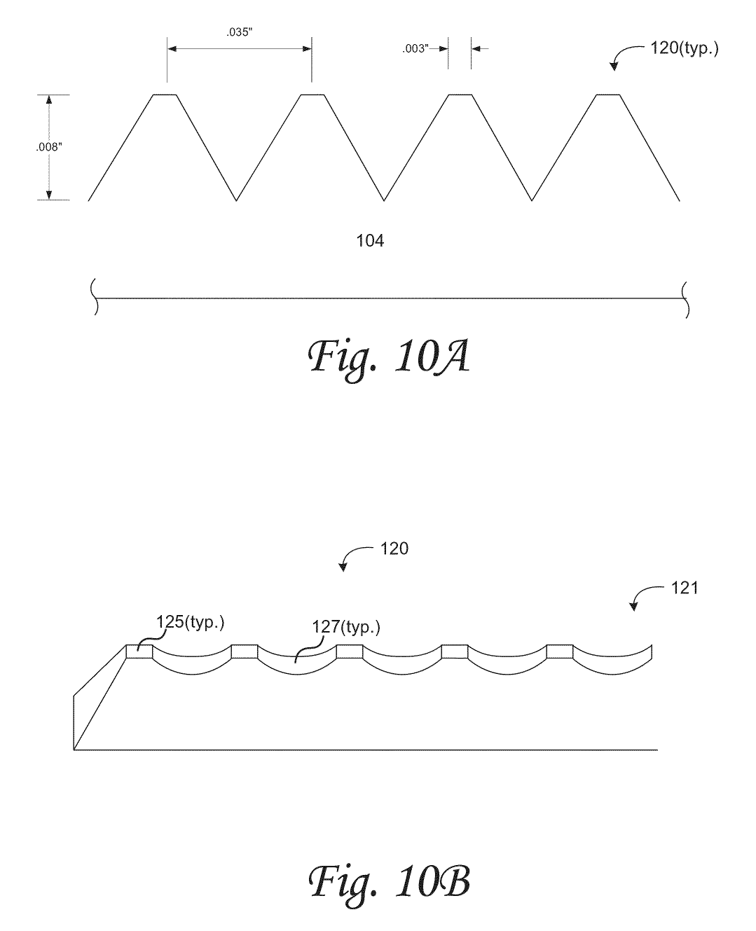

The heights of the textural elements (e.g. pyramids) can vary, but are preferably relatively small. FIGS. 5A and 5B are diagrams illustrating exemplary dimensions for a textured surface in accordance with embodiments described above with reference to FIGS. 9 and 10. In the example of FIG. 5A, the ridges or pyramids are 8 thousandths in height and arranged at a pitch of 19 thousandths. The width of the flattened mesa at the top of the pyramids is 3 thousandths. The angle at the intersection formed between the sidewalls of adjacent pyramids is preferably a right angle, although other angles can be used. Similarly, in the example of FIG. 5B, the pyramids or ridges can be provided with similar dimensions having a pitch of 19 thousandths, a loaded pyramids height of 8 thousandths, and a peak width of 3 thousandths. In in the example embodiment of FIG. 5B, the difference in height between loaded pyramids and unloaded pyramids can be relatively small, on the order of 0.25-4 thousandths. These dimensions are exemplary and can be varied from application to application however, these examples illustrate that the texture provided by the textural elements can be a fine texture. For example, the height of the ridges were pyramids can range from 5 thousandths to 15 thousandths, and the pitch can range from 12 thousandths to 100 thousandths, although in both cases, smaller or larger dimensions can be used. In another example, the ridges 120 are 8 thousandths in height, and are spaced at a pitch of 35 thousandths; the peaks of each ridge are arranged at a pitch of 35 thousandths; the length and width of the flattened mesa at the top of high points 125 are 3 thousandths and 30 thousandths, respectively; and the depth of the depressions 127 is 0.0008″.

FIG. 6, which comprises FIGS. 6A and 6B, provides yet another alternative embodiment for the textural elements of the backing plate. FIG. 6A is a cross sectional view of a textural element in accordance with one embodiment of the technology described herein, while FIG. 6B presents a perspective view. Referring now to FIGS. 6A and 6b, in this example, a ridge 120 is provided with a modified scalloped top surface 121. Surface 121 includes a plurality of high points 125 and depressions 127, which provide a contour to the top of the textural element (e.g., ridge 120).

Also illustrated in FIG. 6A is a conductive layer 46 positioned above backing plate 104. Although conductive layer 46 is shown as spaced apart from the peaks of ridges 120, conductive layer 46 can rest on or come into contact with the peaks of ridged surface 120 provided that conductive layer 46 comprises an insulating layer 46b between conducting layer 46a and backing plate 104. Although not illustrated, when a bias voltage is applied across the emitter, conductive layer 46 will be drawn into more stable contact with scalloped top surface 121, causing layer 46 to contact the high points 125 and, with sufficient bias, be drawn down at least partially into the depressions 127 and valleys between the ridges. Preferably, the bias is not sufficiently strong to draw layer 46 into complete contact with the entirety of the surface of backing plate 104, as some air volume is desired to allow layer 46 to move in response to application of the audio modulated ultrasonic signal.

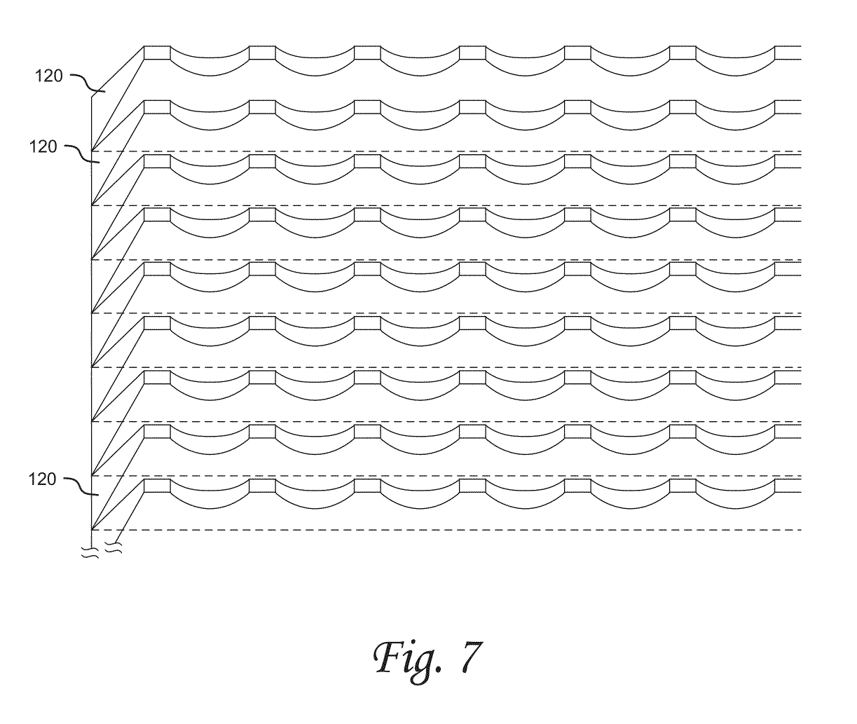

FIG. 7 is a diagram illustrating an example of a contour having a plurality of textural elements such as those illustrated in FIG. 6. In this example, the textural elements are arranged in the form of ridges positioned parallel to one another running across all or part of the backing plate 104. As shown in this example, the textural elements meet in a V at the base of each textural ridge. The angle of the V at the intersection formed between the sidewalls of adjacent pyramids is preferably a right angle, although other angles can be used.

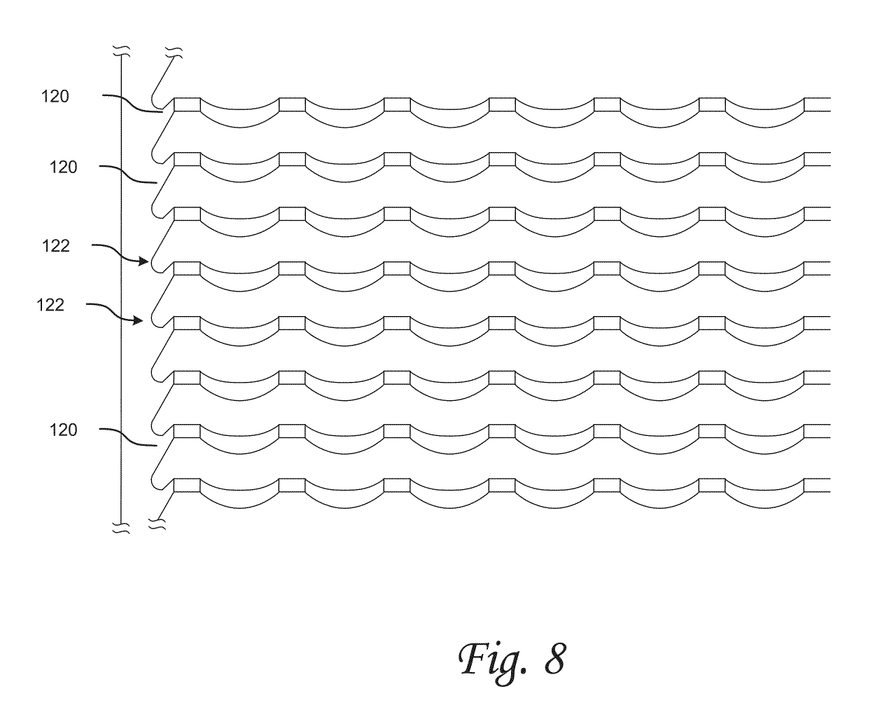

In alternative embodiments, the textural elements do not meet in a V-shaped configuration in the valleys between the ridges. For example, in one alternative the surface between adjacent ridges 120 is a radius surface (e.g. a U-shaped configuration). An example of this is shown in FIG. 8 in which a radiused surface 122 is provided between each of the adjacent ridges 120. As another example, in another alternative, the surface between adjacent ridges 121 has a flat bottom or floor 123. An example of this is shown in FIG. 9, in which the ridges 121 slope downward from their respective peaks (a constant slope in this example, although a curved surface can also be used) and meet at a substantially flat valley floor 123. The transition from ridge slope to valley floor can be sharp, or it can be radiused.

The heights of the textural elements (e.g. ridges 120) can vary, but are preferably relatively small. FIGS. 10A and 10B are diagrams illustrating exemplary dimensions for a textured surface in accordance with embodiments described above with reference to FIGS. 7-10. FIG. 10A presents a cross sectional view looking down along the rows of ridges 120, while FIG. 16B presents a perspective view looking at a single ridge 120 with a plurality of high points 125 and depressions 127. In the example of FIGS. 10A and 10B, the ridges 120 are 8 thousandths in height, and are spaced at a pitch of 35 thousandths. The peaks of each ridge are arranged at a pitch of 35 thousandths; the length and width of the flattened mesa at the top of high points 125 are 3 thousandths and 30 thousandths, respectively; and the depth of the depressions 127 is 0.0008″.

These dimensions are exemplary and can be varied from application to application however, these examples illustrate that the texture provided by the textural elements can be a fine texture. For example, the height of the ridges or pyramids can range from 5 thousandths to 15 thousandths, and the pitch can range from 12 thousandths to 100 thousandths, although in both cases, smaller or larger dimensions can be used.

In these and other embodiments, the depth of the channel between ridges or pyramids can be an important factor in determining the resonance of the film/backplate emitter system. Preferably, the carrier frequency of the modulated ultrasonic signal is chosen to be at or near the resonant frequency of the emitter system for efficient operation. In various embodiments, the resonant frequency is preferably greater than 35 kHz. In further embodiments, the resonant frequency is preferably greater than 50 kHz. In some embodiments, emitter layer 46 can have a natural resonant frequency of anywhere in the range from 30 to 150 kHz, although alternatives are possible above and below this range. In one embodiment, a film/backplate emitter with a resonant frequency of 80 kHz is used.

Likewise, the air volume between film 46 and backing plate 104 can be adjusted to form a resonant system in the range from 30 to 150 kHz, although other frequencies above and below this range are possible. In one embodiment, a carrier frequency of 80 kHz is used and the air volume is configured to give the system resonant frequency of 80 kHz. In various applications, the air volume will be the dominant factor in determining the resonant frequency. In other configurations, the stiffness of the film will dominate and the air volume can be chosen arbitrarily. In other configurations, they both contribute in near equal amounts. Accordingly, design trade-offs can be considered and less than ideal frequency matches utilized.

In the various embodiments, backing plate 104 can be made from Aluminum or other conductive material. Aluminum is desirable due to its light weight and resistance to corrosion. The Aluminum or other conductive material can be machined (e.g., milled), cast, stamped, or otherwise fabricated to form the desired surface pattern for backing plate 104. Additionally, the backing plate can be made from plastic or other non-conductive material and then coated in a conductive material such as nickel or aluminum. This non-conductive backing plate can be injection molded, cast, stamped or otherwise fabricated to form the desired surface pattern.

The emitter can be manufactured using a number of different manufacturing techniques to join layer 46 to backing plate 104. For example, in one embodiment, layer 46 is tensioned along its length and width and fixedly attached to backing plate 104 using adhesives, mechanical fasteners, or other fastening techniques. By way of further example, a relatively flat area around the periphery of backing plate 104 can be provided to present a flat area to which film 46 can be glued or otherwise affixed to backing plate 104. Film 46 can be glued or otherwise secured to backing plate 104 along the entire periphery of backing plate 104 or at selected locations. Additionally, film 46 can be glued or otherwise secured to backing plate 104 at selected points or locations within the periphery. The tension applied to the film during manufacturing is preferably sufficient tension to smooth the film to avoid wrinkles or unnecessarily excess material. Sufficient tension to allow the film to be drawn to the plate upon the application of the bias voltage uniformly across the area of the backing plate is desired. In some applications the amount of tension can be on the order of 10 PSI, although other tensions can be used.

To avoid capturing unwanted air between film 46 and backing plate 104 during attachment operations, one or more air holes can be provided on the back of backing plate 104 to allow air to escape. This can avoid the buildup of unwanted pressure in the air cavity and avoid “ballooning” of the film upon assembly.

Additionally, in some embodiments, the textured conductive surface of the backing plate can be anodized or otherwise provided with a thin coating of insulating material on the top surface. As noted above, in some embodiments, film 46 can be a metallized Mylar or Kapton film with a conducting surface applied to a polymer or other like insulating film. Where the surface of backing plate 104 is anodized, a bi-layer film (e.g. layers 46a, 46b) is not required to insulate film 46 from backing plate 104, and a conducting film (without an insulating layer) can be utilized.

The conductive and non-conductive layers that make up the various emitters disclosed herein can be made using flexible materials. For example, embodiments described herein use flexible metallized films to form conductive layers, and non-metalized films to form resistive layers. Because of the flexible nature of these materials, they can be molded to form desired configurations and shapes. In other embodiments, the layers that make up the emitters can be formed using molded or shaped materials to arrive at the desired configuration or shape.

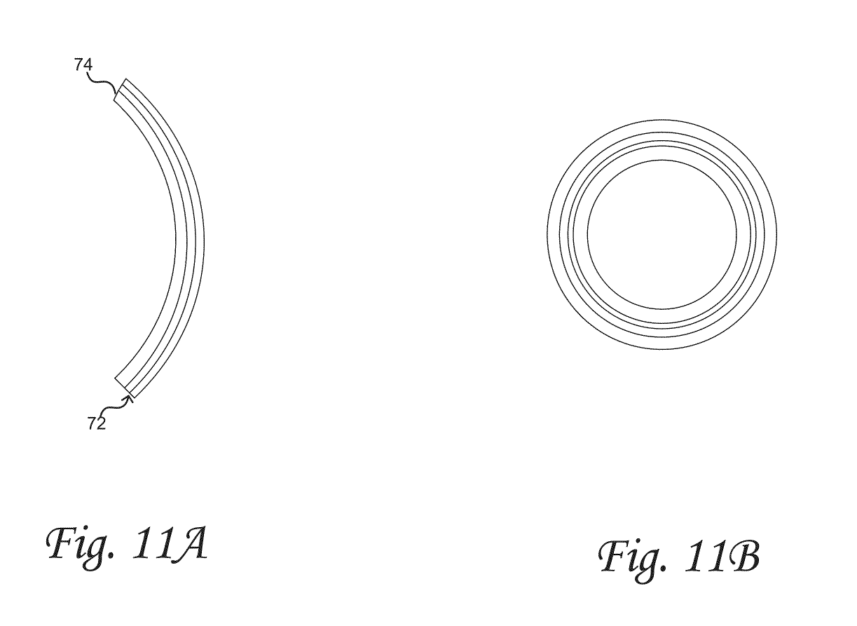

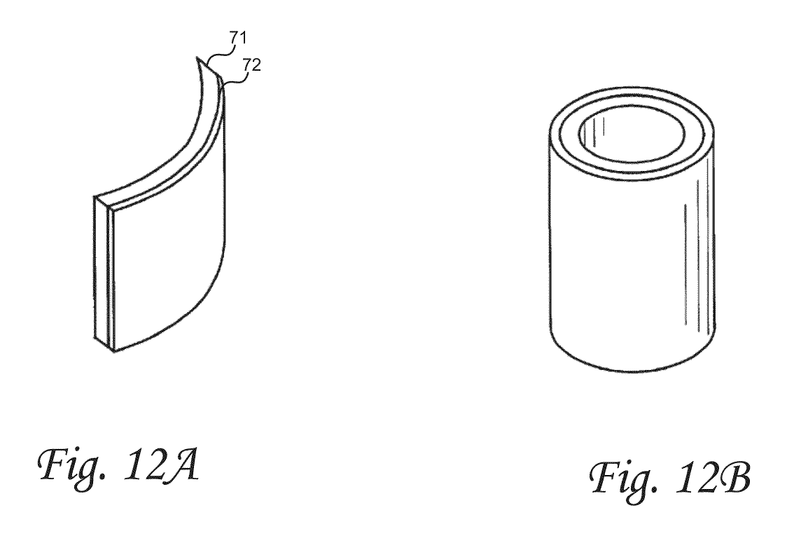

For example, as illustrated in FIG. 11A, the layers can be applied to a substrate 74 in an arcuate configuration. FIG. 11B provides a perspective view of an emitter formed in an arcuate configuration. In this example, a backing material 71 is molded or formed into an arcuate shape and the emitter layers 72 affixed thereto. Other examples include cylindrical (FIGS. 11b and 12b) and spherical. As would be apparent to one of ordinary skill in the art after reading this description, other shapes of backing materials or substrates can be used on which to form ultrasonic emitters in accordance with the technology disclosed herein.

Mylar, Kapton and other metalized films can be tensioned or stretched to some extent. Stretching the film, and using the film in a stretched configuration can lend a higher degree of directionality to the emitter. Ultrasonic signals by their nature tend to be directional in nature. However, stretching the films yields a higher level of directionality. Likewise,

Conductive layers can be made using any of a number of conductive materials. Common conductive materials that can be used include aluminum, nickel, chromium, gold, germanium, copper, silver, titanium, tungsten, platinum, and tantalum. Conductive metal alloys may also be used.

Conductive layers 45, 46 can be made using metalized films. These include, Mylar, Kapton and other like films. Such metalized films are available in varying degrees of transparency from substantially fully transparent to opaque. Likewise, insulating layer 47 can be made using a transparent film. Accordingly, emitters disclosed herein can be made of transparent materials resulting in a transparent emitter. Such an emitter can be configured to be placed on various objects to form an ultrasonic emitter. For example, one or a pair (or more) of transparent emitters can be placed as a transparent film over a heliostat, window, camera lens or other instrumentatlity to form an emitter. This can be advantageous because in some embodiments emitters can be placed on existing objects, or other objects designed to be placed in an environment without requiring additional mounting locations for emitters. Also, because metalized films can also be highly reflective, the ultrasonic emitter can be made into a mirror.

In yet another embodiment, an ultrasonic emitter can be made by affixing to a piece of glass, to a mirror, or to another like substance, one or more piezoelectric transducers that can cause the glass or mirror to vibrate at ultrasonic frequencies and emit the desired ultrasonic energy. Just about any rigid material can be used as an emitter in this configuration such as, for example, glass, Plexiglas, metallic materials, and so on, provided that the material can vibrate, and preferably resonate, at or near the ultrasonic frequency. As also described above, metallized reflective films can also be used as the outer surface of the ultrasonic emitter. In such embodiments, highly reflective films can be chosen to increase the reflectivity of the emitter. Accordingly, as these examples serve to illustrate, reflective emitters can be used to emit the ultrasonic signals (whether or not modulated with audio or other content). As yet another example, a more transparent metallized outer layer can be positioned over a highly reflective backplate to provide an emitter with mirror-like characteristics. For example, transparent conductive films, conductive coated glass (e.g. gorilla glass, Willow glass, or other glasses) can be used as the outer layer of the emitter positioned over reflective backplate. As discussed above, the backplate efficiency can be improved by providing a textured surface on the backplate.

With reflective emitters, the emitters can serve a dual purpose of emitting ultrasonic energy as well as reflecting solar energy to the collectors. This dual purpose is described further below. Therefore, in the example environment, one or more of the mirrors that are used to reflect sunlight onto the collector can also double as an ultrasonic emitter. In other words, highly reflective ultrasonic emitters can be used as mirrors in the solar power generation environment described above. Likewise, highly reflective ultrasonic emitters can be used as mirrors or mirrored surfaces in other applications as well.

The emitters can be chosen of a particular size and shape such that their resonant frequency is at or near the center frequency of the ultrasonic energy to be transmitted. In some embodiments, the resonant frequency of the emitter is the same as or substantially the same as the frequency of the ultrasonic signal. In other embodiments, the resonant frequency of the emitter is within +/−15% of the frequency of the ultrasonic signal. In still other embodiments, the resonant frequency of the emitter is within +/−25% of the frequency of the ultrasonic signal. In yet other embodiments, the resonant frequency of the emitter is within +/−5% of the frequency of the ultrasonic signal.

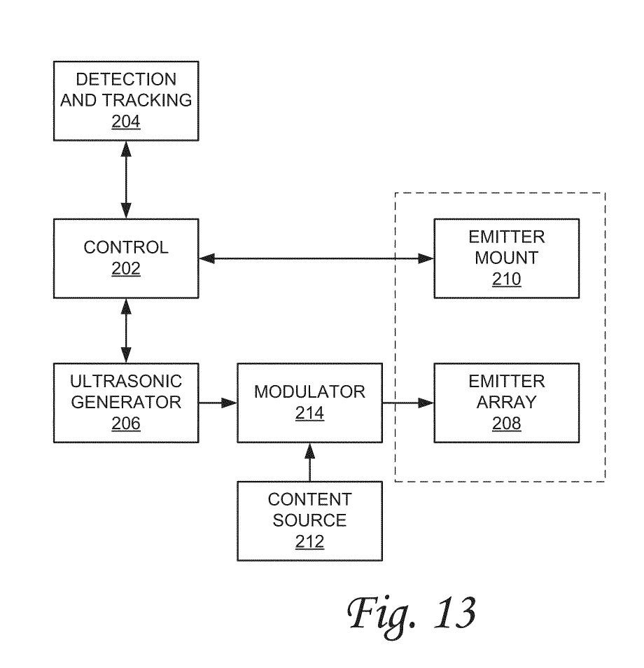

FIG. 13 is a block diagram illustrating an example ultrasonic intrusion deterrence system in accordance with one embodiment of the technology described herein. With reference now to FIG. 13 the system includes a control system 202, a detection and tracking module 204, an ultrasonic frequency generator 206, a plurality of ultrasonic emitters 208, ultrasonic emitter mounts 210, a content source 212 and a mixer 214. Although not shown, an amplifier and other circuitry can also be included. For example, ultrasonic generator 206, content source 212, and modulator 214 can be implemented using one or more channels of the system shown in FIG. 1 or 2. As also described above, ultrasonic generator 206 can be configured to generate an ultrasonic signal that itself is in the hearing range of the intruders or may cause a characteristic frequency to be generated within the intruder's inner, middle, or outer ear. As also described herein, ultrasonic generator 206 can be used to provide an ultrasonic carrier onto which other content (e.g. audio content or other information content) can be modulated to use a modulator 214.

With continued reference to FIG. 13, detection and tracking module 204 can be included to detect the presence of unwanted intruders. Detection and tracking module 204 can also be used in some embodiments to determine a location of potential intruders and to calculate their predicted path or trajectory. In further embodiments, detection and tracking module 204 can be configured to identify the type of intruder based on intruder characteristics such as, for example, the intruder's physical shape, size, speed of travel, travel characteristics (e.g., flight pattern), location, heat signature, sound signature, and so on. Furthermore, a combination of detector technologies can be used to enhance the identification and detection of would-be intruders. For example, a combination of radar, optical, and infrared detection can allow information about the target of multiple types to be correlated and used to provide a better identification. For example, tracking based on radar alone might only provide target location and speed with a rough order of magnitude information on the size of the target, while the addition of optical detection may provide further information such as the shape and movement of the object (e.g., flapping of wings) to further refine the identification. Identification may include identification of the class of objects (e.g., the flapping of wings to identify birds) or the identification of a particular individual or individuals (e.g., facial recognition to identify particular individuals).

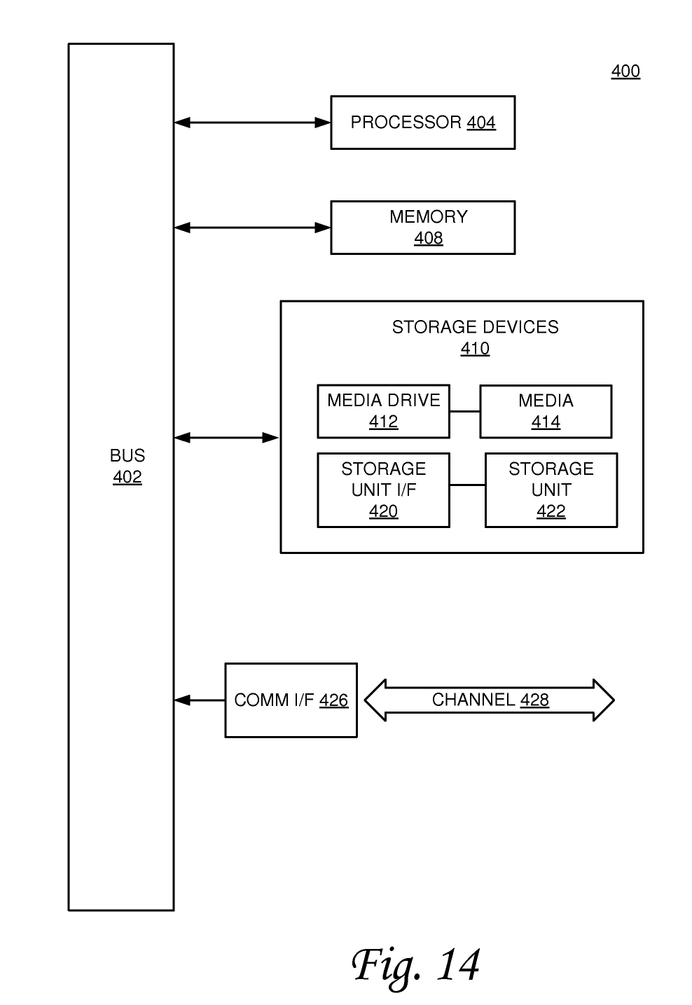

Once a target is detected, it can be identified to determine whether it is an unwanted intruder. Accordingly detection and tracking module 204 can include one or more active or passive sensors such as, for example, optical sensors (including, e.g., image sensors), radar sensors, infrared sensors, and so on. The sensors can be configured to provide information to a processing module (e.g., such as that depicted in FIG. 14) which can include hardware and software to perform functions such as detect the presence of an object, track the movement of the object, predict future movement of the object, and identify the object or object class.

In some environments, identification may be unnecessary or unimportant. For example, in some environments it may be sufficient that an intruder is detected, regardless of its type or identification. As a further example, in environments in which a dangerous condition is present, and that condition could be dangerous to a variety of different creatures, identification may be less important, and indeed, it may be the goal of the system to warn away or deter all would-be entrants. Accordingly, in some embodiments, identification is not used.

Control module 202 can be configured using any of a number of computing modules to receive information from and control the operation of the other modules and components in the system. For example, control module 202 can receive information from detection and tracking module 204 and, based on identification and position information, determine whether to engage ultrasonic generator 206 and aim one or more emitters of emitter array 208 (e.g., using motorized emitter mounts 210).

For example, control module can be configured to engage the system when any intruder is detected, or it can be configured to engage the system only when a certain type of intruder (e.g. based on identification) is detected. As a further example, control modules 202 can be configured to engage system only when an intruder is present in a certain location or locations, or whose path is determined to cause the intruder to enter or come too close to a prohibited region. In some embodiments, control module 202 only activates the ultrasonic signal generator when an intruder (or a particular type of intruder) is detected. In other embodiments, ultrasonic signal generator can remain active at all times that the system is operational.

Emitter array 208 can comprise a plurality of ultrasonic emitters arranged in a manner so as to be able to be positioned to direct emitter ultrasonic energy to a target such as a would-be intruder. Emitter array 208 can comprise a series of independently operated and actuating ultrasonic emitters that can each be independently, or collectively, positioned (i.e. aimed) and energized so as to direct its or their ultrasonic energy toward the target. In other embodiments, emitter array 208 can comprise a phased array, the output of which can be electronically directed to the target. In various embodiments, the emitter mounts 210 can be continuously controlled to allow their associated emitters to track a moving object under the control of control module 202 based on information from detection and tracking module 204. In some embodiments, the emitters can be fixedly mounted in a predetermined orientation and energized based on their orientation. In other embodiments, as described above, the emitters can be mounted on motorized or other steerable mounts such that their orientation can be adjusted to “aim” the emitters at their intended targets.

In some embodiments and applications, the emitter array 208 can be an array of emitters arranged partially or completely about a central axis in a single location to provide ultrasonic energy from a central or other strategic location. In other embodiments, emitter array 208 can comprise a plurality of sets of one or more emitters deployed at various locations about the environment, and preferably in locations where the ability of the emitters to target intruders is optimized. For example, multiple emitter arrays can be positioned about the periphery of a restricted area to provide deterrence in all directions (or in desired directions) around the area from the periphery. As another example, multiple emitter arrays can be positioned at various locations within and outside of the restricted area to provide deterrence in all directions (or in desired directions) around the restricted area. A peripheral arrangement such as this may be desirable over a centralized arrangement in embodiments where the restricted area is large and signal strength may be diminished across that area.

In embodiments using audio or other information content, a content source 212 and modulator 214 can be included. Content source 212 can be used as a source of audio or other informational content that may be used in conjunction with the systems and methods described herein. For example, content source 212 can include a source of audio content with a particular audio track or tracks that may be useful for intrusion deterrence. For example, in the case of birds, content source 212 can provide audio content that would tend to have a deterrent effect on the birds. For example, the sounds of natural predators (e.g. owls), larger birds, or other unpleasant (and preferably unharmful) sounds can be stored as audio content and modulated onto the carrier using modulator 214. In some embodiments, the audio content can be changed periodically or rotated through a variety of different content selections to avoid the birds (or other unwanted intruders) from becoming “accustomed to” a particular sound.

The system of FIG. 13 is now further described in terms of the example environment of a solar thermal power generation system, in which the goal of the system is to keep airborne (e.g. flying) objects away from an out of regions of extreme heat generated by the power generation system. Because of extreme temperatures, birds flying too close to the collector, for example, can be exposed to harmful or even deadly temperatures. Similar dangers may be presented by rotating turbine blades that wind power generation systems. Accordingly, in such environments, detection and tracking module 204 is configured to scan the surrounding skies and identify flying objects in the vicinity of the power generation system. In some embodiments, the presence of any airborne object (or any airborne object greater than a predetermined size) can be sufficient to trigger the deterrent system. In other embodiments, the path or trajectory of the object may also be evaluated by detecting and tracking system to determine whether the object is, for example, merely moving away from the power generation system, or is in fact, heading toward high-temperature regions (or rotating turbine blades, in the case of wind power) of the power generation system. In still further embodiments, detection and tracking module 204 can be used to determine whether the airborne object is an object that the system is intending to deter (e.g. a bird or other like creature that could be harmed by elevated temperatures present).

For ease of discussion and by way of example, assume that detection and tracking module 204 detects the presence of a bird in the vicinity of the power generation system. This information from detection and tracking module 204 is provided to control module 202. This information includes not only the indication of an intruder (i.e. the bird) but also information regarding the bird's location. Control module 202 uses this information to direct ultrasonic energy at the bird's location in an attempt to deter the bird from moving closer to high-temperature regions of the power generation system. In various embodiments, control module 202 can determine which emitters to fire, and, where emitters are positionable, orient the chosen emitters to target the birds. In embodiments where the bird is moving and being tracked, control module 202 can use this information to steer one or more emitters of emitter array 208 along the bird's flight path to provide a more constant deterrent to the bird. As noted above, the emitter array 208 can be steered using mechanized emitter mounts 210 or a phased array of emitters.

In various embodiments, detection and tracking module 204 and control module 202 comprise one or more computing modules programmed or configured to perform the described tasks. These can be implemented as a single computing system perform the described tasks, or two or more separate systems each performing its assigned tasks.

In various embodiments, emitter array 208 can comprise a plurality of emitters mounted on one or more towers configured to be steerable (electronically or mechanically) to direct the ultrasonic energy at the bird or birds. For example, in the case of the example environment described above, the emitters can be placed on dedicated towers or mounted on towers used for other purposes. As a further example, the emitters can be mounted on a mast or other tower on the same structure as the solar collector, or on communications or other towers used for other purposes. In the case of a wind power generation system, for example, emitters or emitter arrays can be mounted on (or on masts or towers mounted on) the solar turbines.

In further embodiments, one or more mirrors that are used by the power generation station to direct solar energy to the collector can be configured to also emit ultrasonic energy and to be steerable to direct this ultrasonic energy to the targets under the direction of control module 202. Accordingly, the heliostats can be configured to be controlled by control module 202 to move from their intended orientation used to generate power to a new orientation used to direct ultrasonic energy toward the intruders. Therefore, in various embodiments, control module 202 may be able to take priority over the motion of some or all of the mirrors in the system to redirect mirrors for the task of intrusion deterrence. As noted above, these mirrors can be implemented using metallized films or mirrored glass, plastic, plexiglass, or other like emitters to provide the full functionality of directing solar energy to the collector as well as directing ultrasonic energy to the intruders.

As a further example, assume the detected intruder is not a bird, but is a hang glider or parachutist, or other intruder capable of understanding speech-based messages. In this example, content source 212 can be used with modulator 214 to modulate a warning message onto the carrier (e.g., ultrasonic or other RF carrier). For example, an audio warning can be modulated onto an ultrasonic carrier providing the hang glider or parachutist with an audible warning that he or she is entering a restricted area or an area of danger.

While the above example using a power generation station is useful to describe the technology in context, one of ordinary skill in the art will appreciate reading this description that this technology is not limited to this particular application or environment. Indeed, the technology and all of its described features can be used in any of a number of different applications or environments where intrusion or other unwanted movement can be adjusted, deterred, or halted to the application of ultrasonic or other electromagnetic energy. For example, pig farmers, cattle farmers, ranchers or other farmers will be able to use an ultrasonic energy direction system such as that described herein to help direct the movement of its livestock or to keep its livestock out of certain identified areas. As another example, a deterrence system can be implemented at airport to deter birds or other flying animals from entering the flight path of airplanes using the airport. As another example, merchants often seek means of keeping birds away from shopping centers and a deterrence system can be implemented at shopping centers, malls, auto dealerships, other retail locations, outdoor cafes and other places frequented by the public to deter birds from entering these restricted areas. As still another example, a deterrence system can be implemented at wharehouses, restuarants, grain storage facilities and other building locations to keep birds, rats or other creatures away.

Additionally, ultrasonic emitters can be used as an electronic fence along the border surrounding the periphery of a restricted area. For example, ultrasonic emitters can be positioned along the border and used to direct ultrasonic energy toward would-be intruders deterring them from crossing the border. The systems can be running a continuous mode or they can be triggered based on intruder detection. As a further example, ultrasonic emitters can be configured to direct ultrasonic energy along a border. Multiple emitters positioned at different heights at the end of the border (or at both ends of the border) can provide a “plane” or wall of ultrasonic energy along the border. This can be done at all borders of the region to provide an ultrasonic wall surrounding a region. Additionally, an ultrasonic ceiling can be created in the same way providing ultrasonic barrier over the region. This energy may be sufficient to cause a would-be intruder (especially unintentional intruder) to reverse course when encountering the wall of ultrasonic energy. These emitters can also be used in conjunction with a detection system such that they do not need to remain energized at all times, but can be energized when needed based on the detection of a possible intruder.

As noted above, the systems and methods described herein are not limited to deterring birds from solar power generation stations, but can be used to deter other intruders (including other mammals or creatures) from intrusion in other environments. As a further example, it may be desirable to deter bats from entering into areas that could be unsafe for them. For example, as noted above, it may be desirable to deter animals from flying near or into the blades of windmills or other like structures. Because bats use ultrasonic frequencies for echolocation (frequently referred to as bat sonar), the systems and methods described herein can be tuned to deter bats from intruding into areas where they would be unwanted for safety or other reasons. Echolocating animals are not limited to bats, and also include some mammals and a few birds, and also whales and dolphins, for example.

Bats use echolocation or sonar as a navigation and ranging system to determine objects in their surrounding environment, and the object's location and distance. Bats emit ultrasound, usually from their mouth or nose. The ultrasound bounces or echoes off of surrounding objects, and the echoed signal is returned to the bat. The bat “hears” the signal through two receivers (e.g., the bat's ears). Because the echoes returning to the two ears arrive at different times and at different levels, the animal can use these differences to perceive distance and direction.

Bat sonar frequencies range from as low as 11 kHz to as high as 212 kHz. Most bats emit frequencies at 30 kHz or higher. Additionally, many bats emit ultrasonic pulses at approximately 80 kHz in frequency. It has also been discovered that some bats emit ultrasonic pulses that range in frequency during the emission. For example, some bats, like the mustached bat, produces a signal at a constant frequency, which is then followed by a downward frequency sweep that is modulated using FM modulation. While still other bats might produce only the constant frequency portion and others only the FM components. Scientists believe that the constant frequency portion is used to detect targets and measure Doppler shift, while the FM portion is used to determine the distance of the object and its finer details.

Because bats rely so heavily on these ultrasonic signals (as sonar) it is possible to deter bats from proceeding to a particular location or area by generating and transmitting ultrasonic signal in the bat's direction. Because the bat uses ultrasound to detect the presence of objects, determine their speed, gauge their distance, and even “see” their features, transmitting ultrasonic signal to the bat can momentarily “blind” the bat or otherwise frighten the bat, and cause it to turn away or move in another direction. Accordingly, transmitting an ultrasonic signal at or near the frequencies detected or ‘seen’ by the bat can cause a bat that is approaching a restricted area to change course and go in another direction. For example, presenting the bat with an ultrasonic signal within a frequency or range of frequencies detectable by the bat, can cause the bat to turn away. This can be due to confusion by the bat, “blindness” or the bat believing it is encountering an object and it needs to change course to avoid hitting the object. The ultrasonic signals transmitted to deter the bat can be generated and transmitted as constant frequency signals, modulated signals (including FM signals) and varying frequency signals. In some embodiments, the ultrasonic signals generated by the deterrent system are generated to match as closely as possible or practical (e.g., given design or cost constraints) signals generated by the bats to facilitate deterrence. For example, the signal generated by the deterrent system can be generated as an FM signal closely matching the FM signal produced by the bat with its own ultrasound. Additionally, the signal generated by the deterrent system can be ramped in frequency to simulate the Doppler effect of an approaching object. With the bat believing that a large object may be approaching the bat can be deterred from continuing on its present path and can be incentivized to retreat away from the detected phantom object.

As with the other environments discussed above, locating transducers at one or more locations throughout the environment, or within or surrounding the restricted area, can be used to direct the ultrasonic signals at the bats that are approaching the restricted area. Detection systems can also be used as described above to detect the presence of approaching bats and to direct the ultrasonic energy in their direction. Additionally, ultrasonic detectors can be used to detect the bat's own ultrasonic signals as part of the detection system.

Ultrasonic emitters were transducers can be positioned or mounted on the windmill towers themselves or on separate towers provided for the purpose of the ultrasonic transducers or for other purposes (e.g. communication towers). As with embodiments described above, the ultrasonic emitters can be grouped in a race or arranged as a phased array to enable directing the signal to the intruding bats. Additionally, in this and other embodiments, curved emitters can be used to provide a wider angle of coverage to increase the ability to reach the intended targets. In further embodiments, the same system can be used to target both bats and birds (as well as other intruders) using shared emitters. For example, even in scenarios where different frequencies are required to deter both bats and birds, the detector can be configured to detect the type of intruder (e.g. is a bat or a bird), configure the oscillator to generate the appropriate ultrasonic signal, provide the appropriate modulation if necessary or desired, and emit the ultrasonic signal.

As noted above, ultrasonic signals (modulated or modulated) can be used to deter would-be intruders of a number of different varieties, and the technology disclosed herein is not limited to deterring birds or bats. However, description of the system in terms of bats and birds as an example enables one of ordinary skill in the art to understand how a similar system can be used to target other creatures or entities. For example, similar systems can be used to deter aquatic creatures (e.g., aquatic fish and mammals) from entering undesired areas or areas of danger. For example, where dangers are present (e.g., hot water outlets from power plant cooling towers) it may be desirable to keep marine life away from such dangers. Accordingly, ultrasonic emitters can be used to emit ultrasonic signals underwater in the direction of approaching aquatic life. In the example of whales or dolphins, ultrasonic signals at or near frequencies detectable by the whales and dolphins can be used to similarly cause the whales and dolphins to turn away from a course that would otherwise lead them toward the danger. Also, the systems and methods described herein can be used to keep sea life away from an area where underwater explorers or workers are working.

Emitters can be placed above or under the water, but underwater emitters may be desirable. Like the other environments described above, detection systems can also be used in underwater environments to detect the presence of approaching aquatic creatures. Sonar or other like techniques can be used for such detection. Likewise detectors tuned to detect the sonar signals emitted from echolocating animals can be used. As with the embodiments described above, the location and type of intruder can be detected in the ultrasonic signals directed toward the intruder.

As used herein, the term set may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

The term tool can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

As used herein, the term module might describe a given unit of functionality that can be performed in accordance with one or more embodiments of the technology disclosed herein. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the technology are implemented in whole or in part using software, in one embodiment, these software elements can be implemented to operate with a computing or processing module capable of carrying out the functionality described with respect thereto. One such example computing module is shown in FIG. 14. Various embodiments are described in terms of this example-computing module 400. After reading this description, it will become apparent to a person skilled in the relevant art how to implement the technology using other computing modules or architectures.

Referring now to FIG. 14, computing module 2000 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 2000 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the illustrated example, processor 404 is connected to a bus 402, although any communication medium can be used to facilitate interaction with other components of computing module 400 or to communicate externally.

Computing module 400 might also include one or more memory modules, simply referred to herein as main memory 408. For example, preferably random access memory (RAM), Flash memory, or other dynamic memory, might be used for storing information and instructions to be executed by processor 404. Main memory 408 might also be used for storing temporary variables or other intermediate information during execution of instructions to be executed by processor 404. Computing module 400 might likewise include a read only memory (“ROM”) or other static storage device coupled to bus 402 for storing static information and instructions for processor 404.

The computing module 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a floppy disk drive, a magnetic tape drive, an optical disk drive, a CD or DVD drive (R or RW), or other removable or fixed media drive might be provided. Accordingly, storage media 414 might include, for example, a hard disk, a floppy disk, magnetic tape, cartridge, optical disk, a CD or DVD, or other fixed or removable medium that is read by, written to or accessed by media drive 412. As these examples illustrate, the storage media 414 can include a computer usable storage medium having stored therein computer software or data.

In alternative embodiments, information storage mechanism 410 might include other similar instrumentalities for allowing computer programs or other instructions or data to be loaded into computing module 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory module) and memory slot, a PCMCIA slot and card, and other fixed or removable storage units 422 and interfaces 420 that allow software and data to be transferred from the storage unit 422 to computing module 400.

Computing module 400 might also include a communications interface 424. Communications interface 424 might be used to allow software and data to be transferred between computing module 400 and external devices. Examples of communications interface 424 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 424 might typically be carried on signals, which can be electronic, electromagnetic (which includes optical) or other signals capable of being exchanged by a given communications interface 424. These signals might be provided to communications interface 424 via a channel 428. This channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 408, storage unit 420, media 414, and channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 400 to perform features or functions of the disclosed technology as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An intrusion system, comprising:
a detection module comprising a processing module and a sensor having an output coupled to the processing module, wherein the detection module is configured to detect an object in a predetermined area and to determine a position of the detected object in the predetermined area;
an ultrasonic generator comprising an oscillator configured to generate an ultrasonic signal; and
an ultrasonic emitter coupled to the ultrasonic generator configured to launch an ultrasonic wave toward the position of the detected object.

2. The intrusion system according to claim 1, further comprising a control module communicatively coupled to the detection module and to the ultrasonic generator, and configured to initiate generation of the ultrasonic signal by the ultrasonic generator upon detection of the detected object in the predetermined area.

3. The intrusion system according to claim 2, wherein the control module is further configured to determine whether to engage the ultrasonic generator based on information received from the detection module before initiating generation of the ultrasonic signal.

4. The intrusion system according to claim 3, wherein the detection module is further configured to identify the object with the object class, and the determination of whether to engage the ultrasonic generator is based on the identification of the object or the object class.

5. The intrusion system according to claim 3, wherein the detection module is further configured to determine a trajectory of the detected object.

6. The intrusion system according to claim 5, wherein the determination of whether to engage the ultrasonic generator is based on the determined trajectory of the detected object.

7. The intrusion system according to claim 2, wherein the control module is configured to initiate generation of the ultrasonic signal when a particular class of objects or a specific person is detected.

8. The intrusion system according to claim 2, the control module is configured to initiate generation of the ultrasonic signal when the object is present at a predetermined location or at one of a plurality of predetermined locations.

9. The intrusion system according to claim 1, further comprising a modulator having an input coupled to the ultrasonic generator and an output coupled to the ultrasonic emitter and configured to modulate audio content onto the ultrasonic signal.

10. The intrusion system according to claim 9, wherein the audio content is audio content configured to alter a trajectory of the detected object or to cause the detected object to leave the predetermined area.

11. The intrusion system according to claim 9, wherein the audio content comprises a warning message to be delivered to a human intruder.

12. The intrusion system according to claim 9, wherein the audio content comprises sounds of natural predators to the detected object.

13. The intrusion system according to claim 1, wherein a frequency of the ultrasonic carrier is selected such that when emitted from the ultrasonic emitter, a sub harmonic distortion of the ultrasonic signal generates a frequency in an audible frequency range of the detected object.

14. The intrusion system according to claim 13, wherein the frequency of the ultrasonic carrier is selected such that the ultrasonic wave results in an auditory signal that is audibly detectable by birds.

15. The intrusion system according to claim 1, further comprising a movable mount onto which the emitter is mounted, and a control module is further configured to adjust the steerable mount to point the emitter in the direction of the detected position of the detected object.

16. The intrusion system according to claim 15, wherein the detection module is further configured to track the movement of the detected object along a path of movement, and wherein the control module is configured to steer the emitter along that path.

17. The intrusion system according to claim 1, wherein the emitter comprises an array of emitters configured as a phased array, and a control module is further configured to adjust a delay in the ultrasonic signal provided to the emitters in the array to steer the ultrasonic wave emitted by the array in the direction of the detected position of the detected object.

18. The intrusion system according to claim 17, wherein the detection module is further configured to track the movement of the detected object along a path of movement, and wherein the control module is configured to steer the phased array to direct the emitted ultrasonic wave along that path.

19. The intrusion system according to claim 2, wherein the detection module is further configured to determine a trajectory of the object and the control module is configured to evaluate the trajectory to determine whether to initiate generation of the ultrasonic signal based on the trajectory of the object.

20. The intrusion system according to claim 2, wherein the emitter comprises a heliostat configured as an ultrasonic emitter, and wherein an orientation of the heliostat is configured to be controlled by the control module.

21. The intrusion system according to claim 1, wherein a frequency of the ultrasonic wave generated by the emitter is within a range of frequencies detectable by bats.

22. The intrusion system according to claim 21, wherein the ultrasonic signal is an FM signal.

23. The intrusion system according to claim 21, wherein the ultrasonic signal is ramped in frequency to simulate a Doppler effect.

24. The intrusion system according to claim 1, wherein the detected object comprises a bird, a bat, a human being, or other mammal.

25. Accordingly, ultrasonic emitters can be used to emit ultrasonic signals underwater in the direction of approaching aquatic life.

26. The intrusion system according to claim 1, wherein the detection module is tuned to detect sonar signals emitted from echolocating animals.

27. The intrusion system according to claim 1, wherein the oscillator is a digital or an analog oscillator.

28. An intrusion deterrence system, comprising:
an ultrasonic signal generator comprising an oscillator configured to generate an ultrasonic signal; and
an ultrasonic emitter coupled to the ultrasonic generator configured to launch an ultrasonic wave representing the ultrasonic signal in a direction of an unwanted intruder in a restricted area.

29. The intrusion deterrence system of claim 28, further comprising a modulator configured to modulate audio content onto the ultrasonic signal, wherein the ultrasonic wave demodulates in the air to reproduce the audio content, and further wherein the audio content comprises content that will cause the unwanted intruder to leave the restricted area.

30. The intrusion deterrence system of claim 29, wherein the unwanted intruder is a bird, and wherein the audio content comprises sounds intended to cause the bird to leave or to not enter the restricted area.

31. The intrusion deterrence system of claim 29, wherein the unwanted intruder is a bird, and wherein the audio content comprises a sound of a natural predator to the bird.

32. The intrusion deterrence system of claim 28, wherein the unwanted intruder is a bird, and wherein the frequency of the ultrasonic signal is selected such that the ultrasonic wave results in an auditory signal that is audibly detectable by birds.
